(19) United States
(12) Patent Application Publication
(10) Pub. No.: US 2007/0041187 A1
(43) Pub. Date: Feb. 22, 2007

(54) Preset welding spot structure of a backlight module

(76) Inventor: T. T. Cheng, Taoyuan County (TW)

Correspondence Address: T.T. CHENG, 235 Chung-Ho, Box 8-24, Taipei, TW

(21) Appl. No.: 11/204,240

(22) Filed: Aug. 16, 2005

(51) Int. Cl. F21V 5/00

(52) U.S. Cl. 362/244; 362/249

(57) ABSTRACT

A backlight module with at least one backup welding spot comprises a backlight module having a support substrate; at least one light emitting diode; at lease one welding spot located near a respective one of the at least one light emitting diode; wherein the welding spot serves to be welded with another light emitting diode so that the another light emitting diode is electrically connected to the support substrate. The support substrate has at least one groove for receiving the light emitting diode. The light emitting diode is enclosed by a lens. When any one of the light emitting diodes on the support substrate cannot work, it is not necessary to detach the lens and the fault light emitting diode. It is only necessary to weld another light emitting diode aside the respective welding spot.

### FIELD OF THE INVENTION

The present invention relates to backlight modules, and in particular to a preset welding spot structure of a backlight module, wherein when any one of the light emitting diodes on the support substrate cannot work, it is not necessary to detach the lens and the fault light emitting diode. It is only necessary to weld another light emitting diode aside the respective welding spot.

### BACKGROUND OF THE INVENTION

With the popularity of digital products and wireless communication, the conventional CRTs (cathode ray tubes) are gradually replaced by liquid crystal display due to the lightweight of these devices, compact size and lower radiation thereof. Thereby LCDs are suitable to be used in various electronic products.

The LCD panel of a LCD is not a light source. Thereby another light source is necessary to emit light to the LCD panel. The light source is a backlight module which is classified into direct emitting type and lateral emitting type. In the direct emitting type, the support substrate of the backlight module is welded with a plurality of LEDs (light emitting diodes). To save cost, the light emitting diodes can be directly formed on the support substrate.

Referring to FIGS. 7 and 8, a prior art backlight module 90 is illustrated. A plurality of light emitting diodes 91 are installed on the support substrate 92. An outer side of each light emitting diode 91 is covered by a lens 83. Referring to FIG. 8, the lens 93 completely encloses the light emitting diode 91. In this prior art structure, when any one of the light emitting diodes on the support substrate has fault, it must be detached for repair. The work is tedious and complicated, even it is possible that the whole backlight module is deserted. With reference to FIG. 9, another prior art structure is illustrated. In this prior art, the light emitting diodes 91 are installed on the support substrate 92. Each light emitting diode 91 is sealed by a lens. For this structure, the problem encountered in the repair also occurs.

### SUMMARY OF THE INVENTION

Accordingly, the primary object of the present invention is to provide a preset welding spot structure of a backlight module, wherein when any one of the light emitting diodes on the support substrate cannot work, it is not necessary to detach the lens and the fault light emitting diode. It is only necessary to weld another light emitting diode aside the respective welding spot.

To achieve above objects, the present invention provides a backlight module with at least one backup welding spot which comprises a backlight module having a support substrate; at least one light emitting diode; at lease one welding spot located near a respective one of the at least one light emitting diode; wherein the welding spot serves to be welded with another light emitting diode so that the another light emitting diode is electrically connected to the support substrate. The support substrate has at least one groove for receiving the light emitting diode. The light emitting diode is enclosed by a lens.

The various objects and advantages of the present invention will be more readily understood from the following detailed description when read in conjunction with the appended drawing.

### BRIEF DESCRIPTION OF THE DRAWINGS

FIG. 1 is a perspective view of the preset welding spot structure of a backlight module of the present invention.

FIG. 2 is a lateral view of the preset welding spot structure of a backlight module of the present invention.

FIG. 3 shows the use of the preset welding spot structure of a backlight module of the present invention.

FIG. 4 is a lateral view about the use of the preset welding spot structure of a backlight module of the present invention.

FIG. 5 is a lateral view of the second embodiment of the present invention.

FIG. 6 is a lateral view showing the use of the second embodiment of embodiment.

FIG. 7 is an elevation view of the prior art backlight module.

FIG. 8 is a lateral view of the prior art backlight module.

FIG. 9 is a lateral view of another prior art backlight module.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

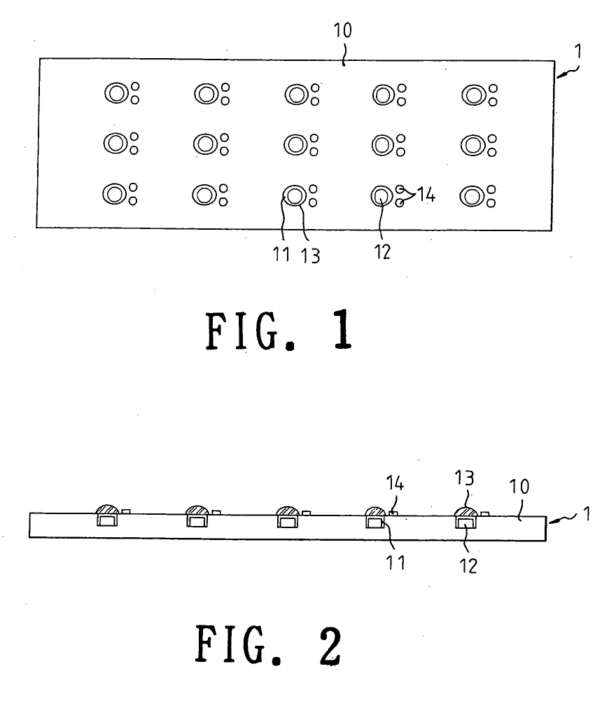

With reference to FIGS. 1 and 2, the preset welding spot structure of a backlight module of the prior art is illustrated. The structure has the following elements.

A backlight module 1 serves for providing light to a liquid crystal display. The backlight module 1 has a support substrate 10. A plurality of cambered grooves 11 are formed on the upper surface of the backlight module 1 for receiving light emitting diodes 12. A periphery of each groove 11 is enclosed by a semi-round lens 13. Fluorescent powders or other additives can be filled between the lens 13 and the groove 11 of the support substrate 10. Above mentioned structure is used in the prior art and is not the claimed feature of the present invention. Thereby the details will not be further described herein.

The features of the present invention will be described herein.

A periphery of each groove 11 has at lease one welding spot 14 at an upper surface of the support substrate. In the drawing, two welding spots 14 for each groove 11 are illustrated.

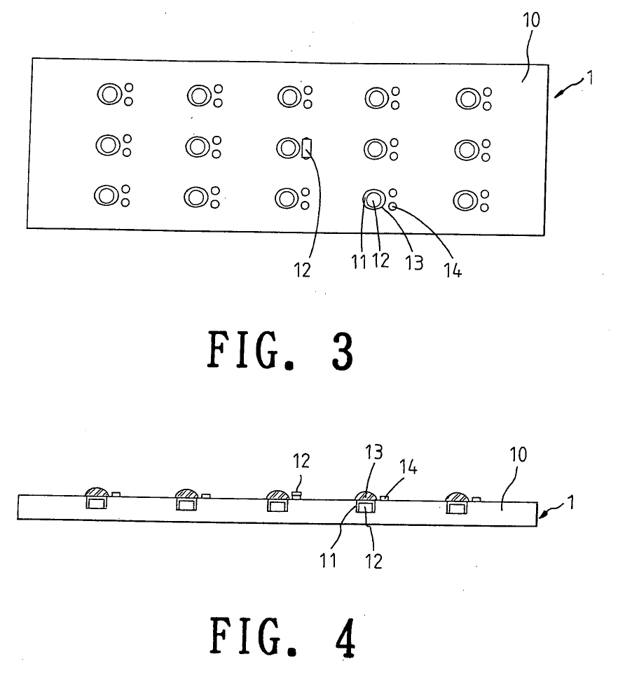

With reference to FIGS. 3 and 4, when any one of the light emitting diodes 12 on the support substrate 10 cannot work, it is not necessary to detach the lens 13 and the fault light emitting diode 12. It is only necessary to weld another light emitting diode 12 aside the respective welding spot 14. The updated light emitting diode 12 can completely replace the old one. Thus, the complicated repair process is avoided.

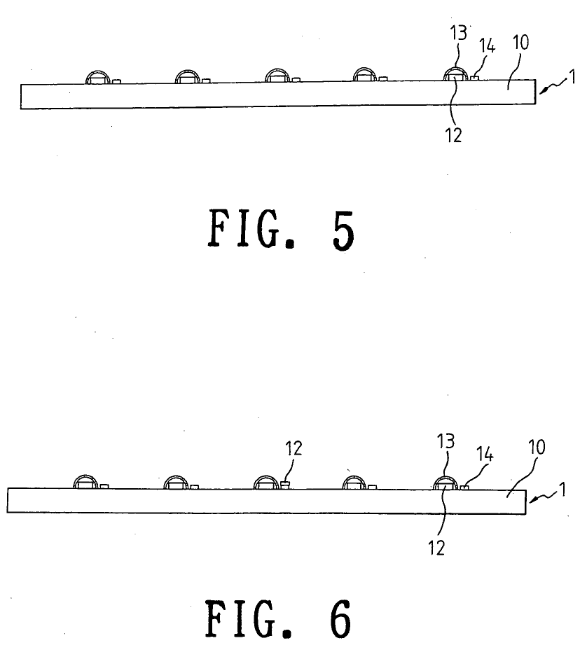

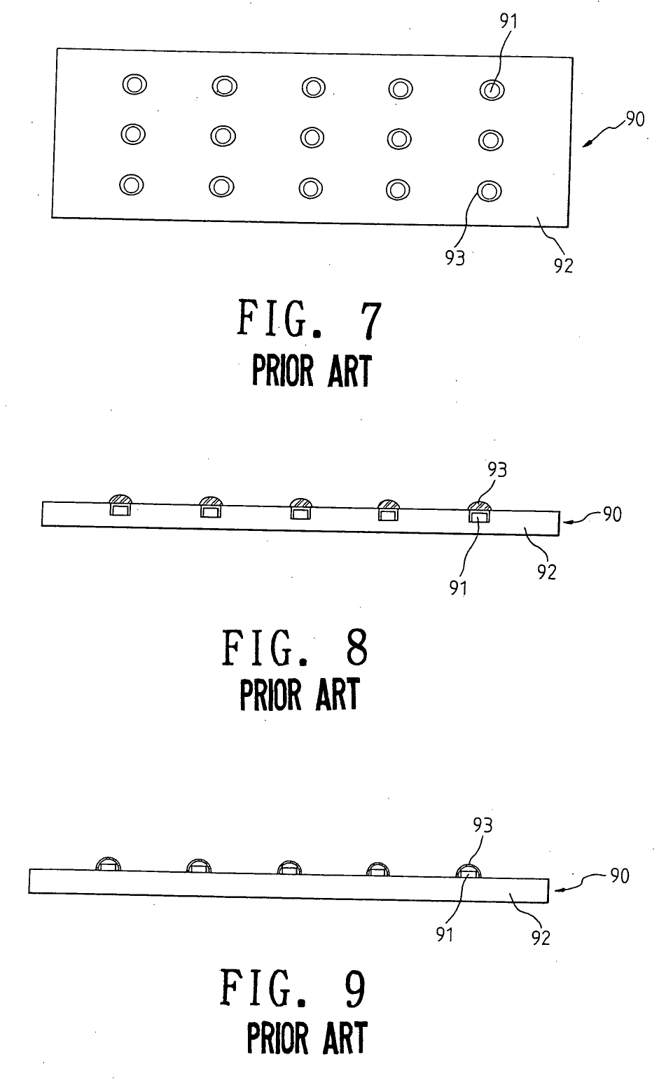

Referring to FIGS. 5 and 6, the second embodiment of the present invention is illustrated. Those identical to the first embodiment will not be further described herein. Only those different are described. In this embodiment, no groove is formed. A plurality of light emitting diodes 12 installed upon an upper surface of the support substrate 10. Each light emitting diode 12 is enclosed by a semi-round lens 13. At least one welding spot 14 is formed aside each light emitting diode 12. Thereby it has the same effect as described above.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A backlight module with at least one backup welding spot comprising:
a backlight module having a support substrate;
at least one light emitting diode;
at lease one welding spot located near a respective one of the at least one light emitting diode; wherein the welding spot serves to be welded with another light emitting diode so that the another light emitting diode is electrically connected to the support substrate.

2. The preset welding spot structure of a backlight module as claimed in claim 1, wherein for each light emitting diode, there are at least two welding spots being formed near the light emitting diode.

3. The preset welding spot structure of a backlight module as claimed in claim 1, wherein the support substrate has at least one groove for receiving the light emitting diode.

4. The preset welding spot structure of a backlight module as claimed in claim 1, wherein the light emitting diode is enclosed by a lens.

5. The preset welding spot structure of a backlight module as claimed in claim 2, wherein the support substrate has at least one groove for receiving the light emitting diode.

6. The preset welding spot structure of a backlight module as claimed in claim 5, wherein the light emitting diode is enclosed by a lens.
